(19) United States
(12) Patent Application Publication
(10) Pub. No.: US 2008/0077733 A1
(43) Pub. Date: Mar. 27, 2008

(54) DATA TRANSFER APPARATUS

(75) Inventor: Hiroyuki USUI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/859,903

(22) Filed: Sep. 24, 2007

(30) Foreign Application Priority Data
Sep. 25, 2006 (JP) 2006-259159

(51) Int. Cl. G06F 12/00

(52) U.S. Cl. 711/109

(57) ABSTRACT

A data transfer apparatus has a controller configured to read out data in a predetermined sequential address area in units of a first byte count and to perform control for transferring the read-out data to a length register having a data area of a second byte count, the second byte count being the first byte count n times, where n is an integer equal to or more than “1”, a mask generator configured to generate mask information so that data already stored into the length register is not overwritten and to provide the controller with the mask information, when last data included in data in the predetermined address range read out from the memory is stored into the length register, and a bit circular configured to circulate each bit of data stored in the length register by the number of bytes in accordance with a lower side bit string of a start address of data in the predetermined address area read out from the memory.

### CROSS REFERENCE TO RELATED APPLICATIONS

This application is based upon and claims the benefit of priority from the prior Japanese Patent Application No. 2006-259159, filed on Sep. 25, 2006, the entire contents of which are incorporated herein by reference.

### BACKGROUND OF THE INVENTION

1. Field of the Invention

The present invention relates to a data transfer apparatus for transferring data from a memory to a register.

2. Description of the Related Art

In general, data transfer between a memory and a register in a processor can only be carried out in a data unit aligned with the boundary of a data width determined to be equal to or less than the data width of the register. For example, when a register width is 32 bits, data transfer is only carried out in a data unit aligned with the boundary of 8 bits, 16 bits or 32 bits (refer to JP-A 9-114733 (KOKAI) and JP-A 2002-82897 (KOKAI)).

The data unit handled by a program is also 8 bits, 16 bits or 32 bits similar to the above-mentioned data unit. As an operation is performed for one data unit, there is no inconvenience if the data unit handled by the program is limited.

However, 64-bit data which is not aligned with the boundary of 32 bits may be transferred to the register to perform an operation in a processor which performs a single instruction multiple data (SIMD) operation wherein a plurality of data are stored in one register and an operation is performed using computing units compliant with the number of the data.

When 64-bit data is transferred to a plurality of registers set at a boundary of 32 bits, the data can be transferred to two registers if the data is aligned with the boundary of 32 bits. However, if the data is not aligned with the boundary of 32 bits, three registers are required, and useless data is stored in parts of the registers. In this case, one more SIMD operation is added for one extra register required. In addition to this, the positions of valid data in the registers have to be aligned by a shift operation if an operation is performed with the data which are not aligned with a 32-bit area. A shift operation of this kind can be performed by a rearrangement instruction generally prepared in an SIMD operator, but most of the rearrangement instructions are intended for two registers, and a large number of instructions are required for processing because a plurality of rearrangement instructions have to be carried out.

In addition, data at an arbitrary position on a memory can be transferred by a load aligner, but measures have to be considered for the case where data to be transferred traverses a cache line, which might lead to the complication of hardware.

Furthermore, image processing is one example of processing in which the SIMD operation is performed, but in the image processing, a matrix operation is often performed using a rectangular area of an image as a matrix. In the matrix operation of the image processing, data has to be transferred between a rectangular area on a memory and the register.

At this point, in order to store each row of the matrix in one register, the transfers between the continuous areas on the memory and the register have to be carried out more than one times as described above. More rearrangements are required to transfer rows which are not aligned with a fixed boundary. Moreover, more instructions are required to store each row of the matrix in one register, so that it is necessary to store the rows of the matrix in the registers and then combine and arrange the data in the respective registers to form the arrangement of the rows. In this case, the load aligner is completely useless.

### SUMMARY OF THE INVENTION

According to one aspect of the present invention, a data transfer apparatus, comprising:

a controller configured to read out data in a predetermined sequential address area in units of a first byte count and to perform control for transferring the read-out data to a length register having a data area of a second byte count, the second byte count being the first byte count n times, where n is an integer equal to or more than “1”;

a mask generator configured to generate mask information so that data already stored into the length register is not overwritten and to provide the controller with the mask information, when last data included in data in the predetermined address range read out from the memory is stored into the length register; and

a bit circular configured to circulate each bit of data stored in the length register by the number of bytes in accordance with a lower side bit string of a start address of data in the predetermined address area read out from the memory.

According to another aspect of the present invention, a data transfer apparatus, comprising:

a controller configured to read out data in a rectangular area in a memory in units of a first byte count and to perform control for transferring the read-out data to a length register having a data area of a second byte count, the second byte count being the first byte count n times, where n is an integer equal to or more than “1”;

a mask generator configured to generate mask information so that data already stored into the length register is not overwritten and to provide the controller with the mask information;

a bit circular configured to circulate each bit of data stored in the length register by the number of bytes in accordance with a lower side bit string of a start address of data in a predetermined area read out from the memory.

### BRIEF DESCRIPTION OF THE DRAWINGS

FIG. 1 is a block diagram showing the schematic configuration of a data transfer apparatus according to a first embodiment of the present invention;

FIG. 2 is a block diagram showing the internal configuration of a controller 5 in FIG. 1;

FIG. 3 is a diagram showing the configuration of a state machine of a central controller 23 in FIG. 2;

FIG. 4 is a flowchart showing one example of the processing operation by the controller 5 according to the first embodiment;

FIGS. 5(a) to 5(f) are diagrams schematically showing the procedure of transferring 96-bit data in a cache memory 3 to a length register 4;

FIG. 6 is a diagram showing the logic of mask generation used by a mask controller 6;

FIG. 7 is a diagram showing the relation between low 2 bits of start addresses of transfer data and cyclic shift amounts;

FIG. 8 is a diagram showing the relation between transfer amounts and cyclic shift ranges;

FIG. 9(a) is a diagram showing data in the length register 4 immediately after the data transfer of 128 bits (before a cyclic shift), and FIG. 9(b) is a diagram showing data in the length register 4 immediately after the data transfer of 64 bits (before a cyclic shift);

FIG. 10 is a block diagram showing the schematic configuration of a data transfer apparatus according to a second embodiment of the present invention;

FIG. 11 is a block diagram showing the internal configuration of a controller 5 in the data transfer apparatus according to the second embodiment of the present invention;

FIG. 12 is a diagram showing the configuration of a state machine of a central controller in FIG. 11;

FIG. 13 is a flowchart showing one example of the processing operation by the controller 5 according to the second embodiment;

FIGS. 14(a) to 14(d) are diagrams schematically showing the procedure of transferring 96-bit data in a cache memory 3 to a length register 4;

FIG. 15 is a block diagram showing the internal configuration of a controller 5 in a data transfer apparatus according to a third embodiment of the present invention;

FIG. 16 is a flowchart showing one example of the processing operation by the controller 5 according to the third embodiment;

FIG. 17 is a diagram showing one example of data in a rectangular area 10 to be transferred in the cache memory 3;

FIGS. 18(a) to 18(f) are diagrams showing the values of the length register 4 after data transfer;

FIG. 19 is a diagram showing the relation between low 2 bits of start addresses of transfer data and cyclic shift amounts;

FIG. 20 is a diagram showing the relation between the row width of the rectangular area 10 and cyclic shift ranges;

FIG. 21 is a diagram showing one example of the rectangular area 10 of a row width of 8 bytes×2 rows;

FIG. 22 is a diagram showing the contents of the length register 4 after the transfer of the data in the rectangular area 10 in FIG. 21 before the cyclic shift of the data;

FIG. 23 is a block diagram showing the internal configuration of a controller 5 in a data transfer apparatus according to a fourth embodiment of the present invention;

FIG. 24 is a flowchart showing one example of the processing operation by a controller 5 according to the fourth embodiment;

FIG. 25 is a diagram showing one example of data in a rectangular area 10 in the cache memory 3;

FIGS. 26(a) to 26(d) are diagrams showing the values of a length register 4 after data transfer;

FIG. 27 is a block diagram showing the schematic configuration of a data transfer apparatus according to a fifth embodiment of the present invention;

FIG. 28 is a diagram showing the configuration of a state machine of a central processor according to the fifth embodiment;

FIG. 29 is a flowchart showing one example of the processing operation by a controller 5 according to the fifth embodiment;

FIG. 30 is a diagram explaining transposition processing in a length register 4;

FIG. 31 is a block diagram showing the schematic configuration of a data transfer apparatus according to a sixth embodiment of the present invention;

FIG. 32 is a diagram showing the configuration of a state machine of a central processor in a controller 5 according to the sixth embodiment;

FIG. 33 is a flowchart showing one example of the processing operation by a controller 5 according to the sixth embodiment;

FIG. 34 is a diagram showing one example of data in a rectangular area 10 to be transferred and transposed in a cache memory 3;

FIGS. 35(a) to 35(e) are diagrams showing the values of a length register 4 after data transfer;

FIG. 36 is a diagram showing a rectangular area 10 composed of 2 rows in which one row has 2 bytes;

FIGS. 37(a) and 37(b) are diagrams showing an example of the data transfer for the rectangular area 10 composed of 2 rows in which one row has 2 bytes;

FIG. 38 is a diagram showing a rectangular area 10 composed of 2 rows in which one row has 3 bytes; and

FIGS. 39(a) and 39(b) are diagrams showing an example of the data transfer for the rectangular area 10 composed of 2 rows in which one row has 3 bytes.

### DETAILED DESCRIPTION OF THE INVENTION

Hereinafter, embodiments of the present invention will be described with reference to the drawings.

### First Embodiment

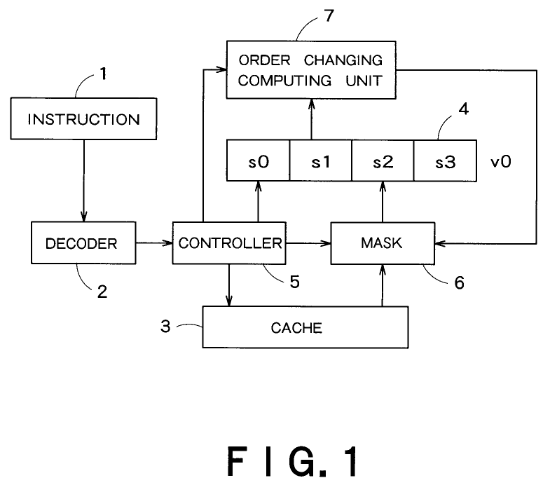

FIG. 1 is a block diagram showing the schematic configuration of a data transfer apparatus according to a first embodiment of the present invention. At least part of the data transfer apparatus in FIG. 1 is implemented inside a processor.

The data transfer apparatus in FIG. 1 comprises a decoder 2 which decodes an instruction issued from an instruction cache 1, a cache memory 3 capable of writing by 32 bits, a length register 4 having a data width of 128 bits and capable of reading by 32 bits, a controller 5 which controls the data transfer from the cache memory 3 to the length register 4, a mask controller 6 which prohibits the overwriting of data stored in the length register 4, and an order changing computing unit 7 which replaces the data stored in the length register 4.

The data transfer apparatus according to the present embodiment can transfer data of an arbitrary length equal to or less than the data width of the length register from the cache memory 3 to the length register 4. The length register has a data area n times (n is an integral number of 1 or more) the read unit (e.g., 32 bits) of the cache memory 3. An example will be described below in which sequential 96-bit data in the cache memory 3 is transferred to the length register 4. The present embodiment is characterized in that data can be transferred from the cache memory 3 to the length register 4 by one instruction even if the initial address of data to be transferred is not located at the boundary of 32 bits.

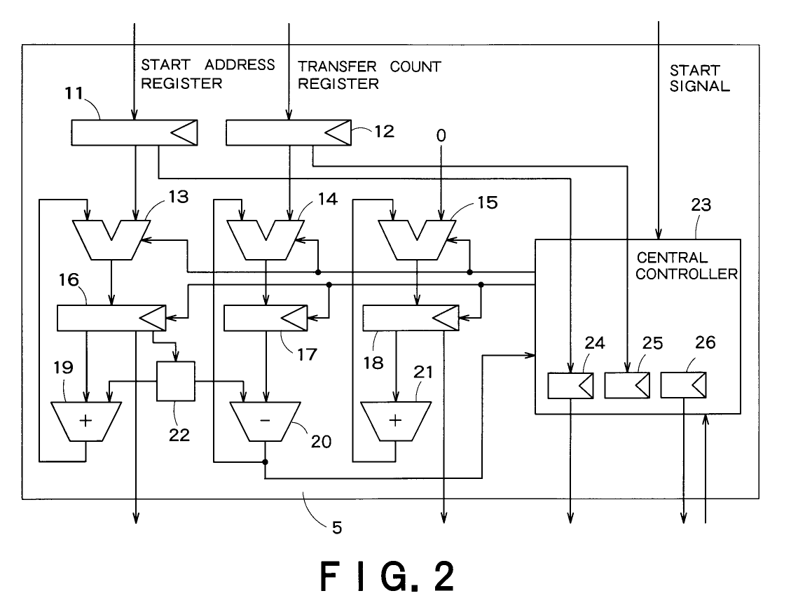

FIG. 2 is a block diagram showing the internal configuration of the controller 5 in FIG. 1. The controller 5 in FIG. 2 has a start address register 11, a transfer count register 12, multiplexers 13, 14, 15, a memory address register 16, a present transfer count register 17, a length register access location register 18, an adder 19, a subtracter 20, an adder 21, a transfer count generator 22 and a central controller 23.

The start address register 11 stores a start address indicating the position of the head of the data to be transferred. The transfer count register 12 stores the number of bytes for a data transfer. When 96-bit data is transferred, 12 (bytes) is stored in the transfer count register 12.

The memory address register 16 stores a memory address which is a read address of the cache memory 3. The present transfer count register 17 stores the number of remaining bytes to be transferred. The length register access location register 18 stores an address indicating a location in the length register 4 which is accessed.

The transfer count generator 22 calculates a difference value between a current memory address and a breakpoint address of 32 bits. When the start address of the data read from the cache memory 3 is not located at the breakpoint of 32 bits, the transfer count generator 22 outputs a difference value between the start address and the breakpoint address immediately thereafter. Subsequently, data is read from the cache memory 3 at every breakpoint of 32 bits, so that the transfer count generator 22 outputs “4” corresponding to 4 bytes.

The adder 19 generates an address in which the difference value stored in the transfer count generator 22 is added to the memory address stored in the memory address register 16. When the start address of the data to be transferred is not located at the boundary of 32 bits, data transfer is started from this start address. However, when the next data transfer is carried out, the difference value up to the boundary of 32 bits is added to the start address, so that an address corresponding to the position of the boundary is output from the adder 19. Then, the adder 19 sequentially outputs values in which 4 is added to the memory address.

The subtracter 20 generates a value in which the difference value stored in the transfer count generator 22 is subtracted from the number of untransferred bytes stored in the present transfer count register 17. When the start address of the data to be transferred is not located at the boundary of 32 bits, a value is generated which is obtained by subtracting the number of bytes from the start address to the breakpoint address immediately after the start address. Subsequently, values are sequentially output in which “4” is subtracted from the number of untransferred bytes stored in the present transfer count register 17.

Each of the multiplexers 13 to 15 selects and outputs one of two input signals in accordance with the logic of a control signal from the central controller 23. The logic of this control signal is switched at the start of data transfer.

More specifically, the multiplexer 13 selects the start address stored in the start address register 11 at the start of data transfer, and then selects the output of the adder 19. Thus, the output of the multiplexer 13 generally increases by four bytes every time data is transferred. The output of the multiplexer 13 is stored in the memory address register 16.

The multiplexer 14 selects a total transfer amount stored in the transfer count register 12 at the start of the data transfer, and then selects the output of the subtracter 20. Thus, the output of the multiplexer 14 decreases by one every time data is transferred. The output of the multiplexer 14 is stored in the present transfer count register 17.

The central controller 23 has a start address low bit column register 24, an original transfer count register 25 and a cache request enable register 26. The central controller 23 stores data to these registers in accordance with the start address supplied from the outside.

The start address low bit column register 24 stores the value of low 2 bits of the start address. The value of the low 2 bits makes it possible to detect a difference value between the start address and the breakpoint address of 32 bits.

The original transfer count register 25 stores as is the total transfer amount set in the transfer count register 12. The cache request enable register 26 stores an access request enable signal for instructing the cache memory 3 to transfer data.

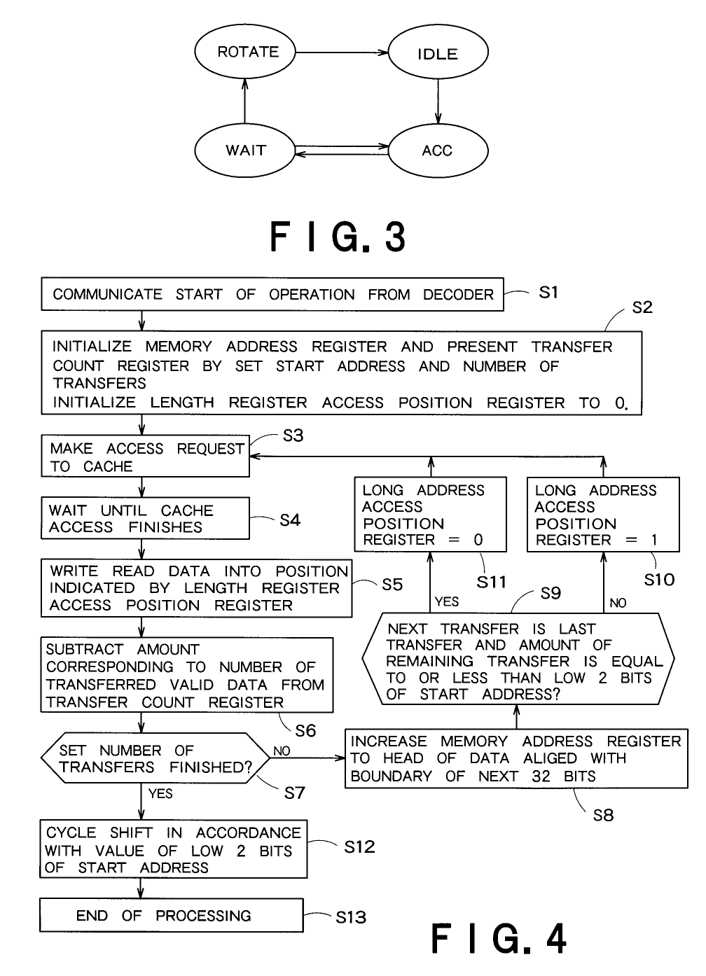

FIG. 3 is a diagram showing the configuration of a state machine in the central controller 23 in FIG. 2. As shown in FIG. 3, the central controller 23 has four operation states: a state IDLE, a state ACC, a state WAIT and a state ROTATE. The central controller 23 is in the state IDLE before the data transfer, and makes the transition to the state ACC when the data transfer is started. The central controller 23 once makes the transition to the state WAIT when the data transfer is finished, and then moves to the state ROTATE to circulate the bit column of the length register 4.

FIG. 4 is a flowchart showing one example of the processing operation by the controller 5 according to the first embodiment. The decoder 2 decodes the instruction issued in the instruction cache 1, and instructs the controller 5 to start data transfer when the instruction turns out to be an instruction to transfer data from the cache memory 3 to the length register 4.

Here, the instruction to transfer data is, for example, LDQW (R0) V0. This instruction instructs to load 96-bit data from the address indicated by a register R0 into a length register 4V0. The processing operation in FIG. 4 is performed only by this one instruction, and the 96-bit data in the cache memory 3 is stored in the length register 4 by each 32 bits.

On receipt of an instruction to start data transfer from the decoder 2 (step S1), the controller 5 initializes the memory address register 16, the present transfer count register 17 and the length register access location register 18 (step S2). More specifically, the start address stored in the start address register 11 is stored in the memory address register 16, and the total transfer amount (12 in this case) stored in the transfer count register 12 is stored in the present transfer count register 17. The length register access location register 18 is initialized to 0.

The length register 4 is divided into four by 32 bits (128 bits in total), and indices such as 0, 1, 2, 3 are assigned to the bits in descending order. For example, the index 0 indicates 127th bit to 96th bit of the length register 4. The values of these indices 0 to 3 are stored in the length register access location register 18. The values stored in this register are the access locations in the length register 4.

Next, the controller 5 makes a request to access the cache memory 3 (step S3), and then waits until a cache access is finished (step S4). Then, the data read from the cache memory 3 is written into an address position indicated by the length register access location register 18 in the length register 4 (step S5).

Next, an amount corresponding to the output of the transfer count generator 22 is subtracted from the value stored in the present transfer count register 17 (step S6). This value indicates the number of untransferred bytes.

Next, the controller 5 judges whether transfers have been finished for the number of transfers stored in the transfer count register 12 (step S7). When the controller 5 judges in step S7 that the transfer has not been finished yet, the value of the memory address register 16 is increased to the address of the boundary position of the next 32 bits (step S8).

Next, the controller 5 judges whether the data transfer by a new memory address set in step S8 is the last data transfer and whether or not the amount of remaining data transfer (the amount of remaining transfer) is equal to or less than the number of bytes indicated by low 2 bits of the start address (step S9).

When the judgment in step S9 results in no, that is, when the data transfer is not the last data transfer or the amount of remaining transfer is greater than the number of bytes indicated by the low 2 bits of the start address, the controller 5 increases the length register access location register 18 by one (step S10), and returns to step S3. On the other hand, when the judgment in step S9 results in yes, that is, when the data transfer is the last data transfer and the amount of remaining transfer is equal to or less than the number of bytes indicated by the low 2 bits of the start address, the controller 5 initializes the length register access location register 18 to 0 (step S11), and returns to step S3.

Thus, the processing in step S11 is performed only when the data previously written is not overwritten even if data is rewritten from the head position of the length register access location register 18. This condition of performing no overwrite corresponds to the case where the amount of remaining transfer is equal to or less than the number of bytes indicated by the low 2 bits of the start address.

When the controller 5 judges in step S7 that transfers have been finished for the number of transfers stored in the transfer count register 12, the length register 4 is cyclically shifted in accordance with the value of the low 2 bits of the start necessary address (step S12).

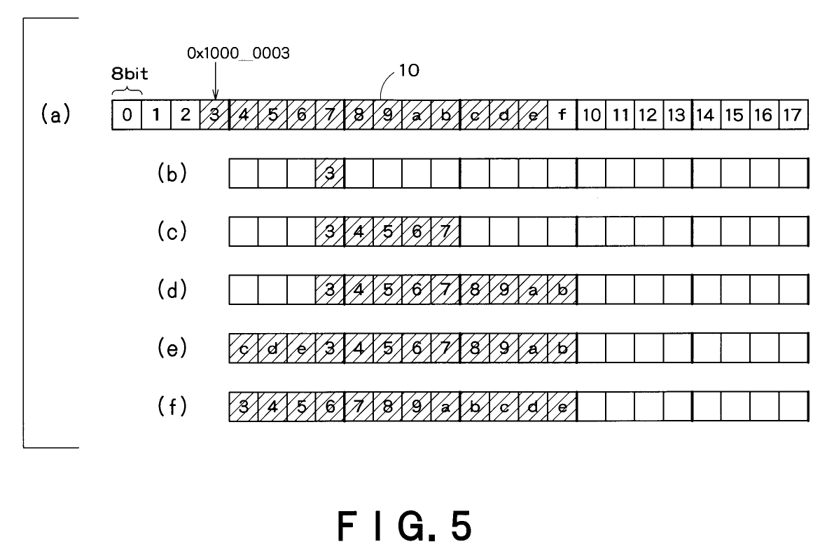

FIG. 5 are diagrams schematically showing the procedure of transferring 96-bit data in the cache memory 3 to the length register 4. FIG. 5(a) represents the data structure of the cache memory 3. Each square represents one-byte (=8-bit) data, and data is read by 32 bits divided by thick lines. A case will be described below where 96-bit data (hatched area in FIG. 5(a)) 10 deviating from the boundaries of 32 bits is transferred to the length register 4.

The start address of the transfer data in FIG. 5(a) is 0X1000_{—}0003. First, one-byte data “3” from the start address to the position of the following boundary is transferred to the length register 4 (FIG. 5(b)). As the data is transferred by 32 bits (4 bytes), 24-bit data of “0, 1, 2” before “3” may be transferred, but these data will be overwritten later and thus do not need to be transferred.

After the first data transfer has been finished, the value of the present transfer count register 17 is decreased by one to 11. The transfer count generator 22 calculates the value “1” of a difference between the start address and the boundary of the following 32 bits, and adds this difference value “1” in the adder 19, and then updates the memory address register 16 to 0X1000_{—}0004.

Since the updated memory address 0X1000_{—}0004 is not the last data, the value of the length register access location register 18 is increased by one in the adder 21, and a request to access the cache memory 3 is made again. Then, this time, “4, 5, 6, 7” of four bytes are read at a time starting from the one-byte data “4” in the cache memory 3 and stored in the length register 4 (FIG. 5(c)).

After the data transfer up to “7” has been finished, the value of the present transfer count register 17 is decreased by “4” to “7”. Since the initial address of the preceding data transfer is at the breakpoint of 32 bits, the transfer count generator 22 outputs “4” up to the next breakpoint. Then, “4” is added to the value of the memory address register 16, and the memory address is updated to 0X1000_{—}8. Further, “1” is added to the value of the length register access location register 18, and the value of the length register access location register 18 becomes 2.

Subsequently, the next 32-bit data “8, 9, a, b” are transferred (FIG. 5(d)), and the value of the memory address register 16 becomes 0X1000_c after the transfer of the 32-bit data has been finished, so that the value of the present transfer count register 17 becomes 3.

The next data transfer is the last one, and data to be transferred are remaining 24-bit data “c, d, e”. In this case, the judgment in step S9 in FIG. 4 results in yes, and the length register access location register 18 becomes 0. The one-byte data “3” transferred first has already been stored in the head 4 bytes of the length register 4, and it is therefore necessary to ensure that this data will not be overwritten. Thus, mask data is generated by the mask controller 6 shown in FIG. 1.

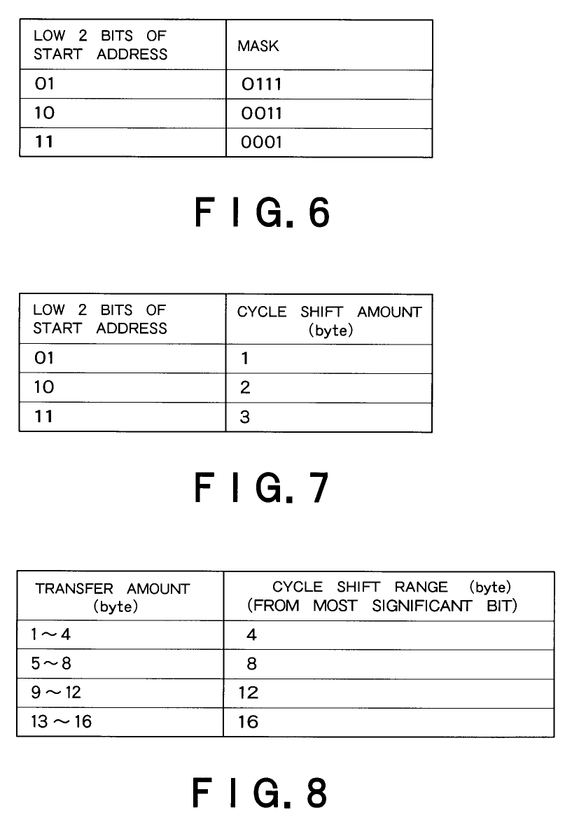

FIG. 6 is a diagram showing the logic of mask generation used by the mask controller 6. As shown, the value of the low 2 bits of the start address of the transfer data determines a mask value. The value of the low 2 bits is set as a reference because the value of the low 2 bits indicates how far the head position of the transfer data deviates from the boundary of 32 bits. In the example of FIG. 5, the value of the low 2 bits is 3, and the mask controller 6 therefore selects a mask value “0001”. The mask value is on a byte-by-byte basis, and a mask value of 1 means that masking is carried out (the overwriting of data is prohibited).

Therefore, in the case of FIG. 5, the already transferred fourth byte “3” among four bytes at the head in the length register 4 is only masked, and the last data “c, d, e” are stored in the remaining three bytes (FIG. 5(e)).

This completes the data transfer from the cache memory 3 to the length register 4. Next, the order changing computing unit 7 in FIG. 1 performs the cyclic shift processing of data in the length register 4. FIG. 7 is a diagram showing the relation between the low 2 bits of the start addresses of the transfer data and cyclic shift amounts, and FIG. 8 is a diagram showing the relation between transfer amounts and cyclic shift ranges. In the case of the example of FIG. 5, the low 2 bits of the start address are “11”, so that the cyclic shift amount is 3 (bytes) in accordance with FIG. 7. Further, 96-bit (12-byte) data is transferred in FIG. 5, so that the cyclic shift range is 12 bytes in accordance with FIG. 8.

The order changing computing unit 7 performs the cyclic shift in accordance with the cyclic shift amount and the cyclic shift range. When the data before the cyclic shift is as shown in FIG. 5(e), the data is cyclically shifted to the left by 3 bytes on a 32-bit basis. Thus, 96-bit data as shown in FIG. 5(f) is finally obtained.

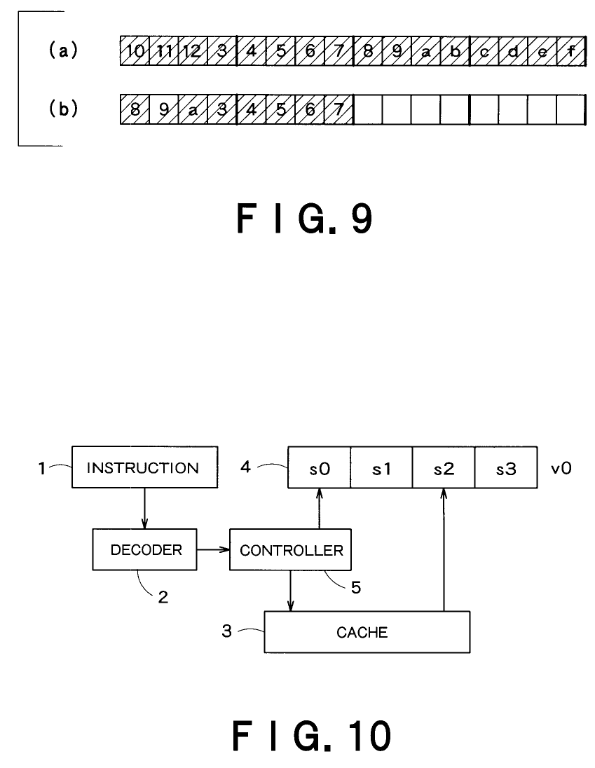

Although the transfer of the 96-bit data has been described with FIG. 5, the present invention is also applicable to the transfer of data having a width of, for example, 64 bits or 128 bits. FIG. 9(a) is a diagram showing data in the length register 4 immediately after the data transfer of 128 bits (before the cyclic shift), and FIG. 9(b) is a diagram showing data in the length register 4 immediately after the data transfer of 64 bits (before the cyclic shift).

The cyclic shift amount is “3” and the cyclic shift range is 16 bytes in the case of FIG. 9(a), while the cyclic shift amount is “3” and the cyclic shift range is 8 bytes in the case of FIG. 9(b). Thus, the cyclic shift range has to be changed in accordance with the number of bits of the transfer data.

As described above, in the first embodiment, even if the start address of the transfer data deviates from the position of the boundary of 32 bits of the cache memory 3, the data transfer from the cache memory 3 to the length register 4 can be indicated by only one instruction, so that the number of instructions can be reduced. Moreover, the transfer processing when the start address deviates from the position of the boundary of 32 bits is performed by hardware, and it is therefore not necessary to consider on the software whether the start address of the transfer data deviates from the position of the boundary of 32 bits, thereby making it possible to reduce overhead required for the operation.

### Second Embodiment

While the example has been described in the first embodiment where the start address of transfer data deviates from the position of the boundary of 32 bits, the internal configuration of the controller 5 can be simplified and the processing operation of the data transfer apparatus becomes simpler if the start address of the transfer data is always located at the boundary of 32 bits. Thus, in a second embodiment below, a data transfer apparatus will be described in the case where the start address of the transfer data is always located at the boundary of 32 bits.

FIG. 10 is a block diagram showing the schematic configuration of the data transfer apparatus according to the second embodiment of the present invention. In FIG. 10, the same signs are assigned to components common to FIG. 1, and different points are mainly described below.

The data transfer apparatus in FIG. 10 has a configuration in which the mask controller 6 is eliminated from the configuration in FIG. 1. In the case of the second embodiment, mask processing is unnecessary because the start address is located at the boundary of 32 bits.

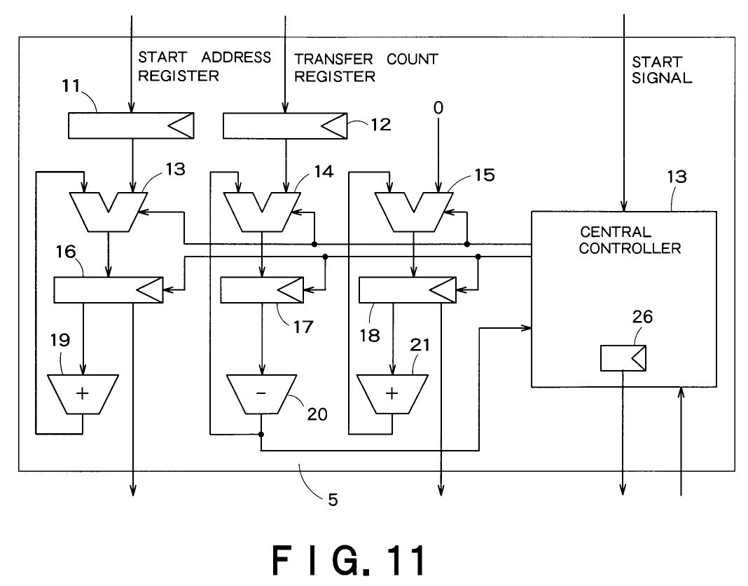

FIG. 11 is a block diagram showing the internal configuration of a controller 5 in the data transfer apparatus according to the second embodiment of the present invention. In FIG. 11, the same signs are assigned to components common to FIG. 2, and different points are mainly described below.

In the configuration of the controller 5 in FIG. 11, the transfer count generator 22 is eliminated from the controller 5 in FIG. 2, and the start address low bit column register 24 and the original transfer count register 25 in the central controller 23 are also eliminated.

“4” is added to a memory address register 16 in an adder 19 every time data is transferred. “4” is also subtracted from a present transfer count register 17 in a subtracter 20 every time data is transferred.

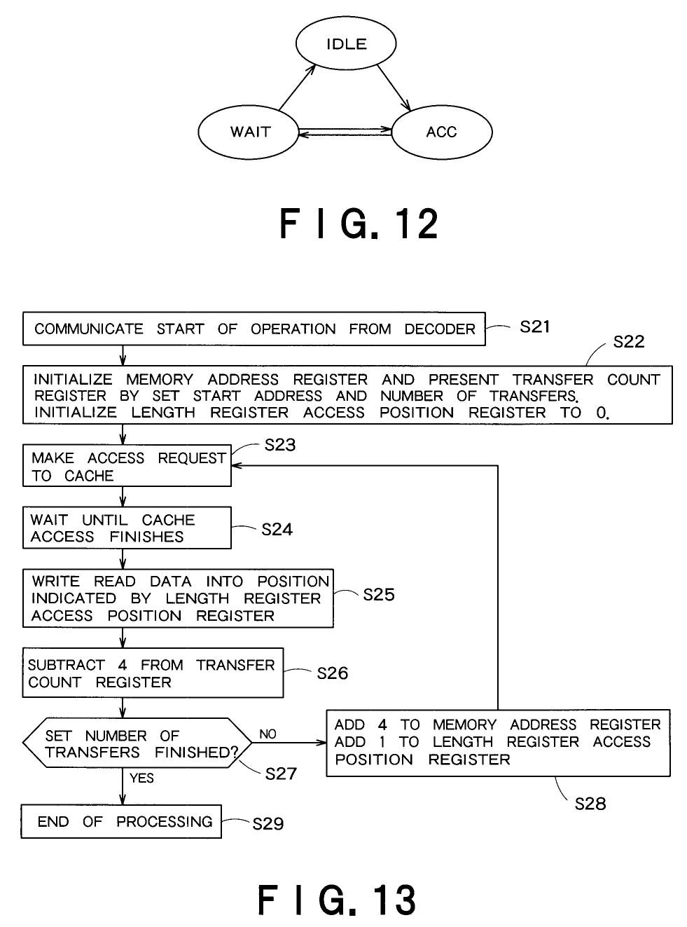

FIG. 12 is a diagram showing the configuration of a state machine of a central controller in FIG. 11. As shown in FIG. 12, a central controller 23 has three operation states: a state IDLE, a state ACC and a state WAIT. The central controller 23 is in the state IDLE before the data transfer, and makes the transition to the state ACC when the data transfer is started. The central controller 23 makes the transition to the state WAIT when the data transfer is finished, and then returns to the state IDLE.

FIG. 13 is a flowchart showing one example of the processing operation by the controller 5 according to the second embodiment. On receipt of an instruction to start data transfer from a decoder 2 (step S21), the controller 5 stores in the memory address register 16 the start address in a start address register 11, and stores in a present transfer count register 17 a total transfer amount in a transfer count register 12. Moreover, the controller 5 initializes a length register access location register 18 to 0 (step S22).

Next, the controller 5 makes a request to access a cache memory 3 (step S23), and then waits until data of four bytes is read from the cache memory 3 (step S24).

Next, the read data is written into the position indicated by the value of the length register access location register 18 in a length register 4 (step S25). Then, “4” is subtracted from the value of the present transfer count register 17 (step S26).

Next, the controller 5 judges whether all the data transfers have been finished (step S27). If all the data transfers have not been finished yet, “4” is added to the value of the memory address register 16, and “1” is added to the value of the length register access location register 18 (step S28). Then, the processing after step S23 is carried out.

On the other hand, if the controller 5 judges in step S27 that all the data transfers have been finished, the processing in FIG. 13 is finished (step S29).

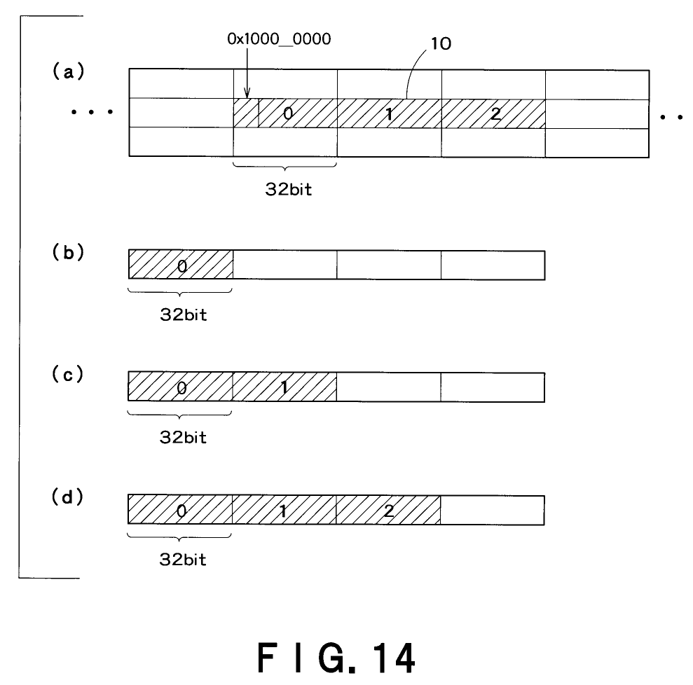

FIG. 14 are diagrams schematically showing the procedure of transferring 96-bit data in the cache memory 3 to the length register 4. FIG. 14(a) represents the data structure of the cache memory 3. In the present embodiment, the start address of the transfer data is located at the boundary of 32 bits, and data of 96 bits (hatched area) is read from an address 0X1000_{—}0000 in FIG. 14(a).

FIG. 14(b) represents the value of the length register 4 after the first data transfer. First 32 bits are stored at the position of a value 0 in the length register access location register 18. In the same manner, FIGS. 14(c) and 14(d) represent the values of the length register 4 after the second and third data transfers. All the data transfers are completed when the third data transfer is finished.

Thus, in the second embodiment, sequential data having a width larger than the read unit of the cache memory 3 can be transferred to the length register 4 by one instruction without the necessity of indicating the data transfer by a plurality of instructions, such that software processing can be simplified. Moreover, as the data transfer processing is performed by hardware, data can be transferred at an extremely high velocity.

### Third Embodiment

In a third embodiment, data in a rectangular area within a cache memory 3 is transferred to a length register 4.

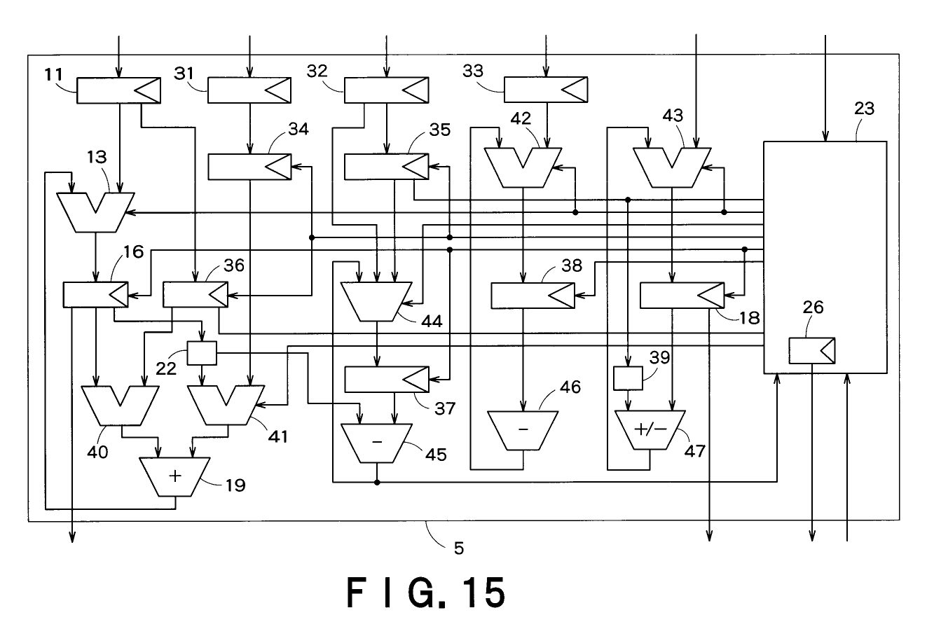

FIG. 15 is a block diagram showing the internal configuration of a controller 5 in a data transfer apparatus according to the third embodiment of the present invention. In FIG. 15, the same signs are assigned to components common to FIG. 2, and different points are mainly described below.

The controller 5 in FIG. 15 is equipped with most of the components in the controller 5 in FIG. 2, but is not equipped with the transfer count register 12. In addition, as components which are not present in the controller 5 in FIG. 2, the controller 5 in FIG. 15 comprises an inter-row memory address amount setting register 31, a row width register 32, a row count register 33, an inter-row memory address position register 34, an in-row transfer amount initial value register 35, an initial address register 36, an in-row transfer amount register 37, a row count register 38, a next candidate selector 39, multiplexers 40 to 44, subtracters 45, 46, and an adder-subtracter 47.

The inter-row memory address amount setting register 31 stores the address of a difference between adjacent rows in the rectangular area to be transferred. The row width register 32 stores the row width in the rectangular area. The row count register 33 stores the number of rows in the rectangular area.

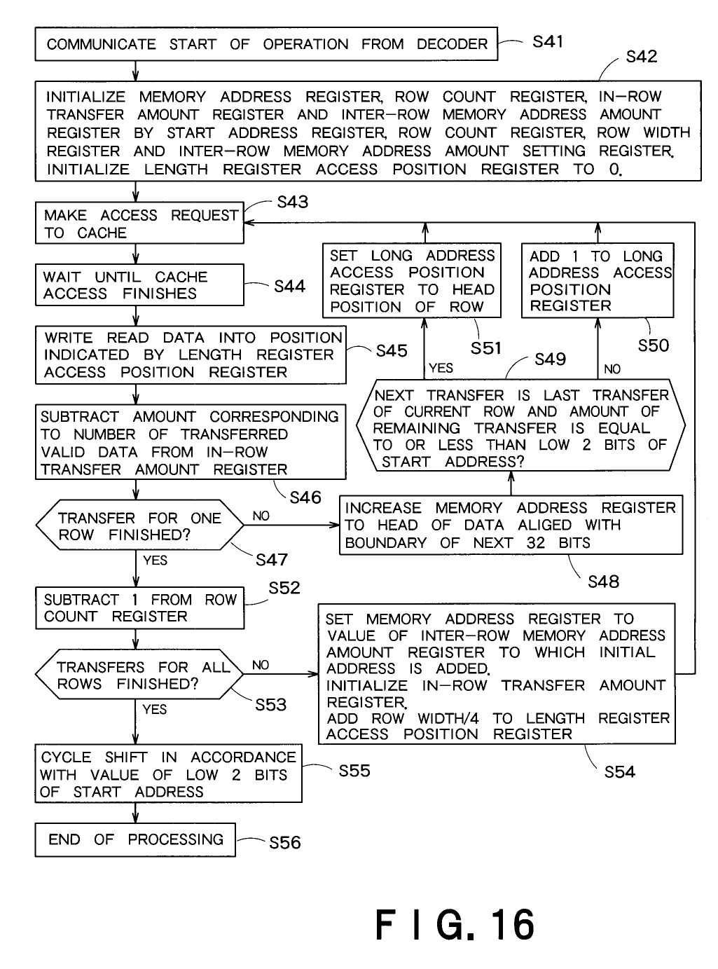

FIG. 16 is a flowchart showing one example of the processing operation by the controller 5 according to the third embodiment. While the transfer of sequential data can be indicated by one instruction in the first embodiment, this can be achieved by one instruction by preparing a dedicated instruction in the case of the rectangular area as well. This dedicated instruction has as parameters the start address, data width, the number of rows, transfer destination (in this case, a length register 4) of the rectangular area. Alternatively, a normal load instruction may be used to refer to a particular register storing the data width and the number of rows of the rectangular area.

On receipt of such an instruction to start data transfer from a decoder 2 (step S41), the controller 5 stores in a memory address register 16 the start address stored in a start address register 11, stores in the row count register 38 the number of rows stored in the row count register 33, stores in the in-row transfer amount register 37 the row width stored in the row width register 32, and stores in the inter-row memory address position register 34 the difference address stored in the inter-row memory address position register 34, and the controller 5 initializes a length register access location register 18 to 0 (step S42).

Next, the controller 5 sends to the cache memory 3 a request to read from a start address 0X1000_{—}0000 in the memory address register 16 (step S43). In response to this, the cache memory 3 reads data of 32 bits from 0X1000_{—}0000 in the same manner as the normal load instruction. The controller 5 waits until the reading of the data of 32 bits from the cache memory 3 finishes (step S44).

When the reading of the data of 32 bits is finished, the read data is stored in a position in the length register 4 indicated by the value (in this case, 0) stored in the length register access location register 18 (step S45).

Next, the number of transferred valid data bytes is subtracted from the value of the in-row transfer amount register 37 (step S46).

Next, it is judged whether data transfer for one row in the rectangular area has been finished (step S47). If it has not been finished yet, the value of the memory address register 16 is updated to the position of the boundary of the next 32 bits (step S48).

Next, it is judged whether the data transfer corresponding to the updated value of the memory address register 16 is the last data transfer of the row and whether the amount of remaining data transfer (the amount of remaining transfer) is equal to or less than the number of bytes indicated by low 2 bits of the start address (step S49). If it is not the last data transfer or if the amount of remaining transfer is greater than the number of bytes indicated by the low 2 bits of the start address, the length register access location register 18 is increased by one (step S50), and the processing after step S43 is carried out.

On the other hand, when the judgment in step S49 results in yes, that is, when the data transfer is the last data transfer and the amount of remaining transfer is equal to or less than the number of bytes indicated by the low 2 bits of the start address, the length register access location register 18 is initialized to “0” (step S51), and a return is made to step S43.

Thus, the processing in step S51 is performed only when the data previously written is not overwritten even if data is rewritten from the head position of the length register access location register 18. This condition of performing no overwrite corresponds to the case where the amount of remaining transfer is equal to or less than the number of bytes indicated by the low 2 bits of the start address.

When it is judged in step S47 that the data transfer for one row has been finished, “1” is subtracted from the row count register 38 (step S52).

Next, it is judged whether the data transfers for all the rows in the rectangular area have been finished (step S53). If not, the value of the memory address register 16 is updated to a value to which the value of the inter-row memory address position register 34 is added. Then, the in-row transfer amount register 37 is initialized, and the value of the length register access location register 18 is initialized to row width/4 (step S54). Then, the processing after step S43 is repeated.

On the other hand, when it is judged in step S53 that all the data transfers have been finished, the cyclic shift is carried out in accordance with the value of the low 2 bits of the start address of the transfer data (step S55), and all the processing is finished (step S56).

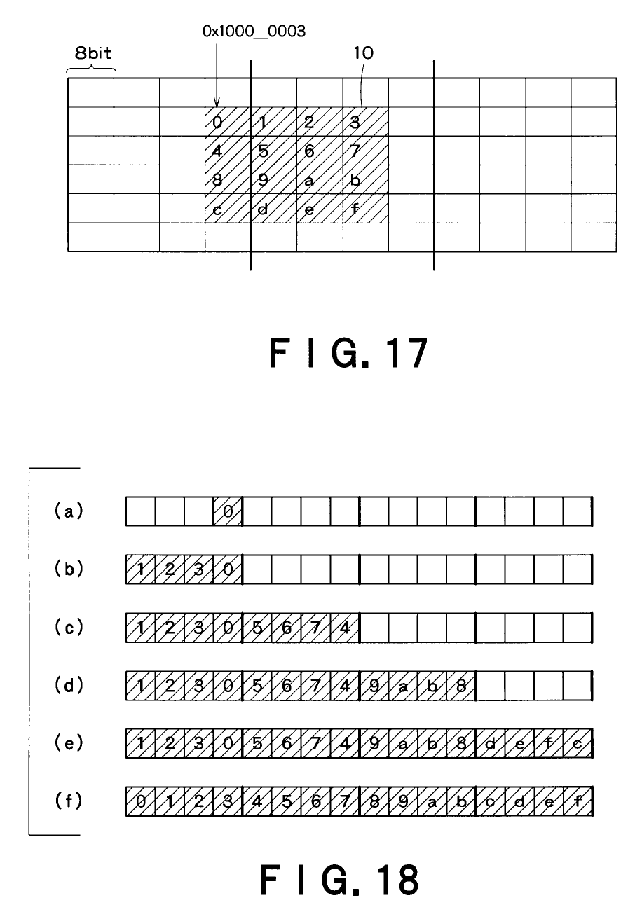

FIG. 17 is a diagram showing one example of data in a rectangular area 10 to be transferred in the cache memory 3, and FIG. 18 are diagrams showing the values of the length register 4 after data transfer. A start address 0X1000_{—}0003 of the rectangular area 10 in FIG. 17 is different by 1 byte from the position of the boundary of 32 bits. The processing operation of the data transfer apparatus according to the present embodiment will be described below in detail in connection with an example in which the data in the rectangular area 10 in FIG. 17 is transferred to the length register 4.

Before the start of data transfer, 0X1000_{—}0003 is stored in the start address register 11, 4 (bytes) is stored in the row width register 32, “4” is stored in the row count register 33, and 0X0000_{—}0100 is stored in the inter-row memory address amount setting register 31.

The setting of these registers may be carried out by issuing an instruction such as a store instruction or control register write instruction by software or may be carried out by using some hardware. When a load instruction targeting the length register 4 as a destination is decoded, the information is sent to the controller 5, and the controller 5 starts operation.

The controller 5 makes a request to read from an address 0X1000_{—}0000 to the cache memory 3. The cache memory 3 reads data by 32 bits (4 bytes), and the read data is stored in a position in the length register 4 indicated by the length register access location register 18 (in this case, 0) (FIG. 18(a)).

Valid data in 32 bits of the address 0X1000_{—}0000 is 1 byte of an address 0X1000_{—}0003. Therefore, after the reading of the data of 1 byte, “1” is subtracted from the value of the in-row transfer amount register 37. First 3 bytes in the length register 4 will be overwritten later, so that any data may be stored at this moment.

When the first data transfer is finished, the memory address is updated to 0X1000_{—}0004. Since the data transfer with this address is the last data transfer in the row, the value of the length register access location register 18 is set to the head position 0 of the row.

Furthermore, mask processing is performed by a mask controller 6 during the last data transfer in the row. In the case of the rectangular area 10 in FIG. 17, data to be transferred are “1, 2, 3”, and 1-byte data after 3 needs to be masked. This mask processing is performed by the mask controller 6 shown in FIG. 1.

When such mask processing is performed, 3-byte data of “1, 2, 3” are stored before “0” in the length register 4, as shown in FIG. 18(b).

This completes the data transfer for one row, and the row count register 38 decreases by one to 3. When this register is not 0, it means that untransferred rows are remaining. Therefore, the memory address register 16 is updated to a value 0X1000_{—}0103 to which the value of an inter-row memory register is added. Then, the in-row transfer amount register 37 is initialized to 4, and the length register access location register 18 is updated to a value (in this case, 1) to which 1 is added, and then an access request is made to the cache memory 3.

The data transfer for the second row of the rectangular area 10 in FIG. 17 is carried out in the same procedure as that of the first row, so that data “4” of the address 0X1000_{—}0103 is first stored in the length register 4, and then remaining “5, 6, 7” are stored before “4” (FIG. 18(c)).

Subsequently, similar processing is performed for the third and fourth rows of the rectangular area 10. When the data transfers up to the fourth row are finished, the value of the row count register 38 becomes 0, and the data transfer is finished.

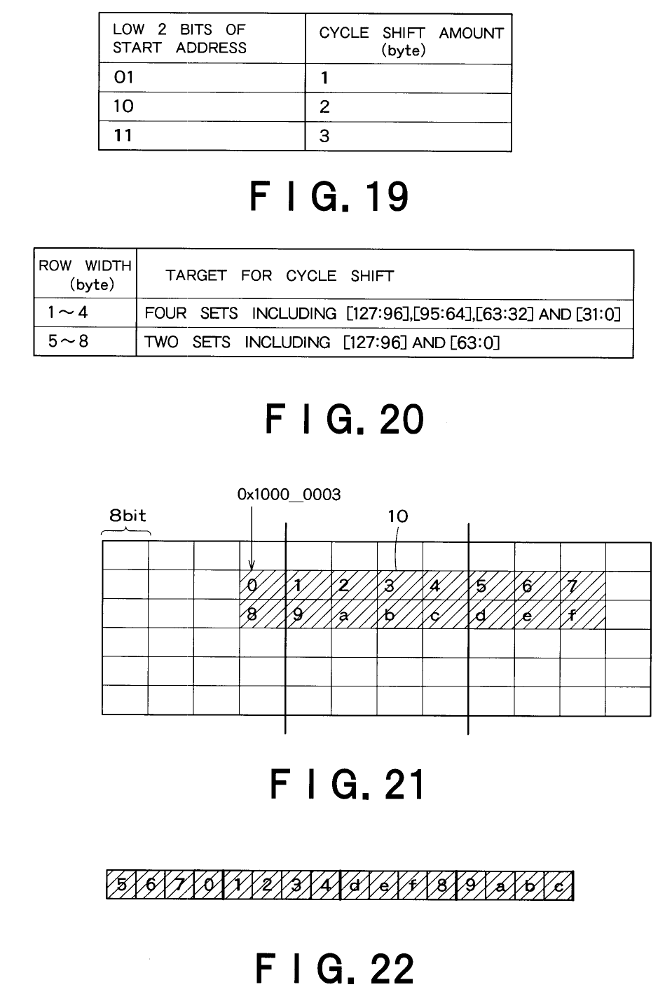

Then, the order changing computing unit 7 shown in FIG. 1 performs the cyclic shift of the length register 4. FIG. 19 is a diagram showing the relation between the low 2 bits of the start addresses of transfer data and cyclic shift amounts, and FIG. 20 is a diagram showing the relation between the row width of the rectangular area 10 and cyclic shift ranges. As the low 2 bits of the start address of the rectangular area 10 in FIG. 17 are “11”, the cyclic shift amount is “3” in accordance with FIG. 19. Further, data in the rectangular area 10 having a row width of 32 bits is transferred in FIG. 17, so that the cyclic shift range includes four sets of 32 bits in accordance with FIG. 20.

The order changing computing unit 7 cyclically shifts the length register 4 to the left by 32 bytes on a 32-bit basis in accordance with the cyclic shift amount selected in FIG. 19 and the cyclic shift range selected in FIG. 20.

Although the example has been described with FIG. 17 in which the data in the rectangular area 10 of a row width of 4 bytes×4 rows is transferred, the size of the rectangular area 10 is not limited to the size in FIG. 17. For example, FIG. 21 shows one example of the rectangular area 10 of a row width of 8 bytes×2 rows. FIG. 22 shows the contents of the length register 4 after the transfer of the data in the rectangular area 10 in FIG. 21 before the cyclic shift of the data. As shown, the last data “5, 6, 7” of the row are arranged before the data “0” of the start address of the rectangular area 10, and the following 4-byte data “1, 2, 3, 4” of the start address are arranged in this order after “0”. The same applies to the second row.

Therefore, when the length register 4 in FIG. 22 is cyclically shifted, the first 8-byte data “5, 6, 7, 0, 1, 2, 3, 4” and the following 8 bytes are targeted for the cyclic shift.

Thus, in the third embodiment, the data in the rectangular area 10 located at an arbitrary portion within the cache memory 3 can be transferred to the length register 4 in a simple manner and at a high velocity. In particular, in the third embodiment, a simple instruction is issued so that the data can be transferred by hardware at a high velocity even if the start address of the rectangular area 10 is not located at the position of the boundary of 32 bits.

### Fourth Embodiment

While the example has been described in the third embodiment in which the start address of the transfer data in the rectangular form deviates from the position of the boundary of 32 bits, the internal configuration of the controller 5 can be simplified and the processing operation of the data transfer apparatus becomes simpler if the start address of transfer data is always located at the boundary of 32 bits. Thus, in a fourth embodiment below, a data transfer apparatus will be described in the case where the start address of the transfer data in the rectangular form is always located at the boundary of 32 bits.

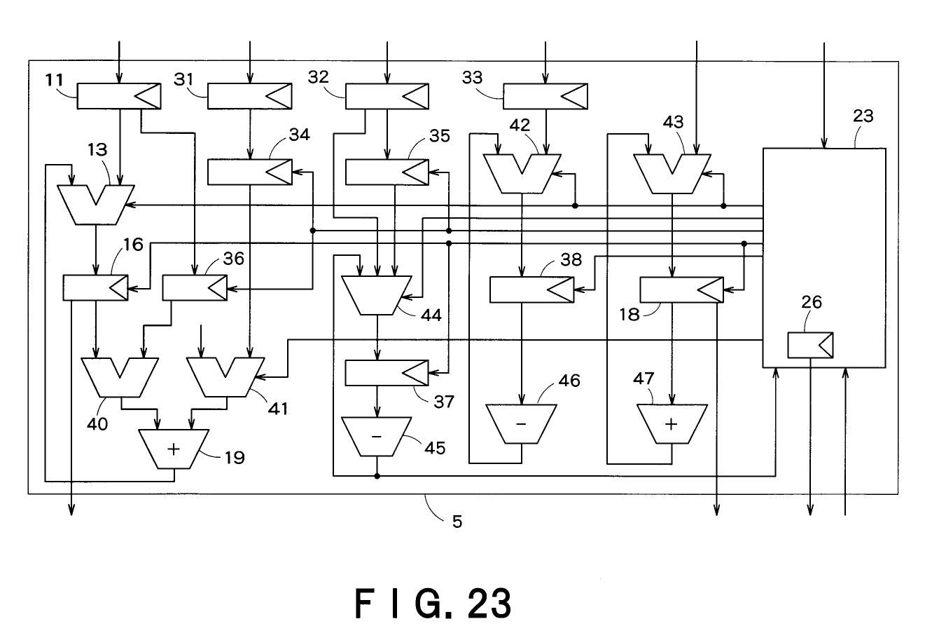

FIG. 23 is a block diagram showing the internal configuration of a controller 5 in the data transfer apparatus according to the fourth embodiment of the present invention. In FIG. 23, the same signs are assigned to components common to FIG. 15, and different points are mainly described below.

The controller 5 in FIG. 23 has a configuration in which the transfer count generator 22 and the next candidate selector 39 are eliminated from the configuration of the controller 5 in FIG. 15, and the configuration is the same in other respects.

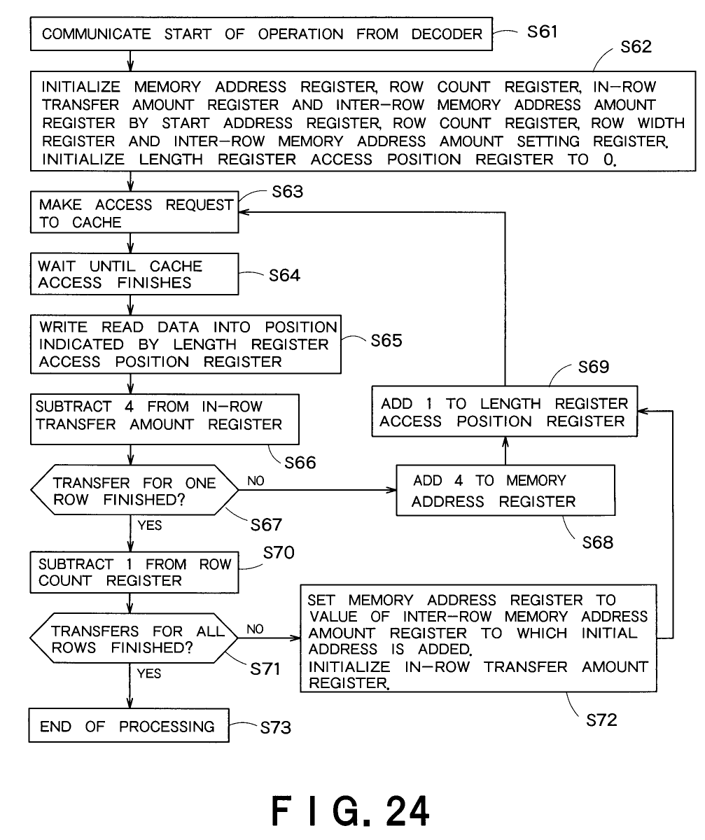

FIG. 24 is a flowchart showing one example of the processing operation by the controller 5 according to the fourth embodiment. On receipt of an instruction to start data transfer from a decoder 2 (step S61), each register is initialized as in step S42 (step S62). Then, an access request is made to a cache memory 3 (step S63), and the controller 5 waits until the reading of the data of 4 bytes from the cache memory 3 finishes (step S64).

Next, the read data is written into the position indicated by the value of a length register access location register 18 in a length register 4 (step S65). Then, “4” is subtracted from the value of an in-row transfer amount register 37 (step S66), and it is judged whether the data transfer for one row in the rectangular area 10 has been finished (step S67).

When the data transfer for one row has not been finished yet, “4” is added to the value of a memory address register 16 (step S68), and “1” is added to the value of the length register access location register 18 (step S69), and then the processing after step S63 is carried out.

When it is judged in step S67 that the data transfer for one row has been finished, “1” is subtracted from the value of a row count register (step S70), and it is judged whether the data transfers for all the rows in the rectangular area 10 have been finished (step S71). If not, the value of the memory address register 16 is set to a value to which the value of an inter-row memory address position register 34 is added, and the in-row transfer amount register 37 is initialized (step S72).

On the other hand, when it is judged in step S71 that the transfers of all the rows in the rectangular area 10 have been finished, the data transfer processing in FIG. 24 is completed.

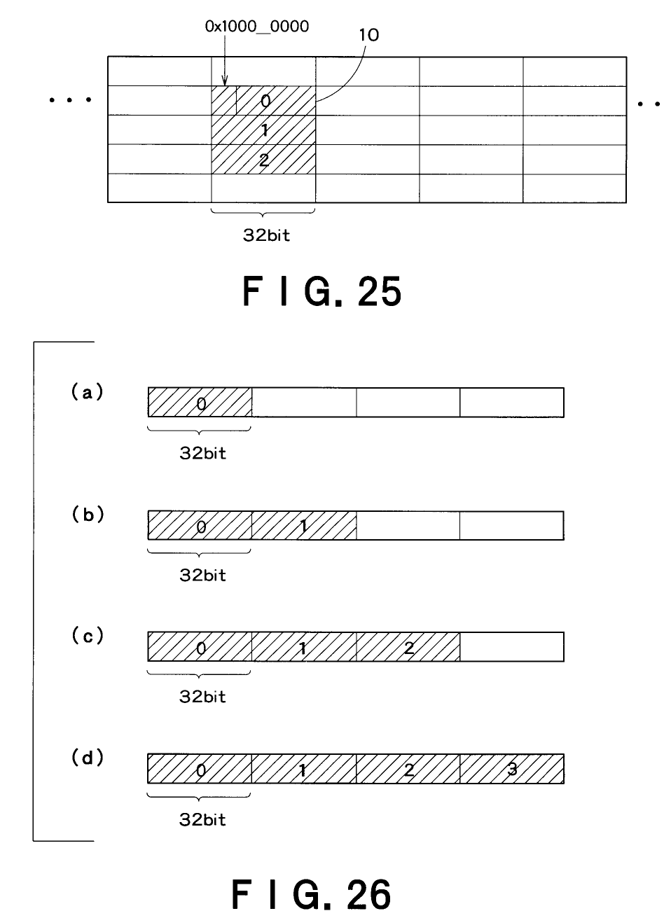

FIG. 25 is a diagram showing one example of data in the rectangular area 10 in the cache memory 3, and FIG. 26 are diagrams showing the values of the length register 4 after data transfer. The start address of the data in the rectangular area 10 in FIG. 25 is located at the boundary of 32 bits, so that mask processing necessary in the third embodiment is not required. First, 4 bytes out of a start address 0X1000_{—}0000 is read from the cache memory 3 and stored in the length register 4 (FIG. 26(a)).

Next, 32-bit data in the second row in the rectangular area 10 is read and stored in the length register 4 (FIG. 26(b)). Subsequently, 32-bit data in the third and fourth rows in the rectangular area 10 are read in order and stored in the length register 4 (FIG. 26(c), FIG. 26(d)).

Thus, in the fourth embodiment, the data in the rectangular area 10 in the cache memory 3 is transferred by hardware, so that the velocity of the data transfer processing can be increased. Moreover, the transfer of the data in the rectangular area 10 can be indicated by only one instruction, so that the burden on a programmer can be reduced.

### Fifth Embodiment

In a fifth embodiment, transposition processing for exchanging a column with a row in a length register 4 is carried out after data in a rectangular area 10 in a cache memory 3 has been transferred to the length register 4.

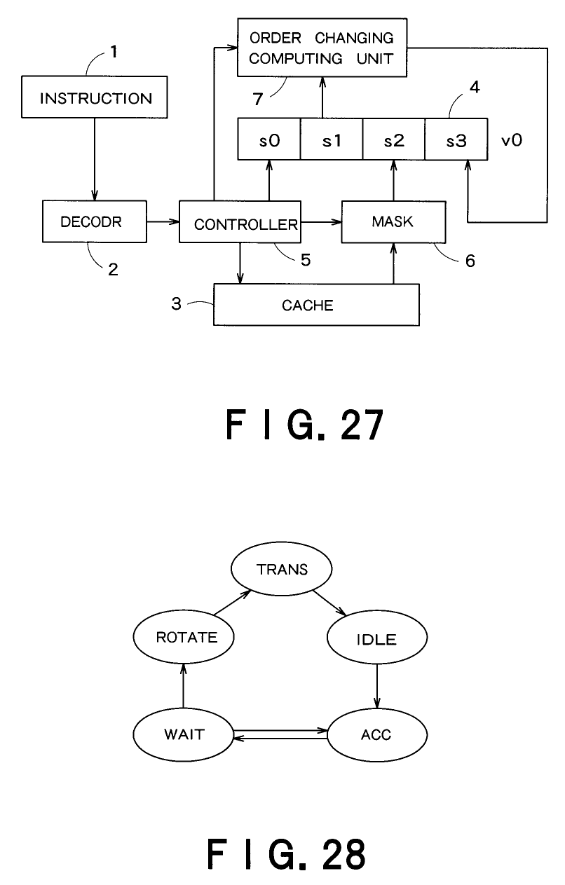

FIG. 27 is a block diagram showing the schematic configuration of a data transfer apparatus according to the fifth embodiment of the present invention. The data transfer apparatus in FIG. 27 is different from the data transfer apparatus in FIG. 1 in the contents of the processing of the order changing computing unit 7. The order changing computing unit 7 in FIG. 27 performs the transposition processing for exchanging a column with a row in the rectangular area 10 and storing the result in the length register 4 in addition to cyclic shift processing in the length register 4 after data transfer.

The internal configuration of a controller 5 shown in FIG. 27 is the same as that in FIG. 15, so that the configuration and the processing operation thereof are not described. However, the controller 5 in FIG. 27 is different from the controller 5 shown in FIG. 15 in the processing operation of a central processor therein.

FIG. 28 is a diagram showing the configuration of a state machine of the central processor according to the fifth embodiment. As shown, the central processor has five operation states: a state IDLE, a state ACC, a state WAIT, a state ROTATE and a state TRANS. The central controller 23 is in the state IDLE before the data transfer, and makes the transition to the state ACC when the data transfer is started. The central controller 23 makes the transition to the state WAIT when the data transfer is finished, and then makes the transition to the state ROTATE when the cyclic shift processing is carried out. Then, the central controller 23 makes the transition to the state TRANS when the transposition processing is performed.

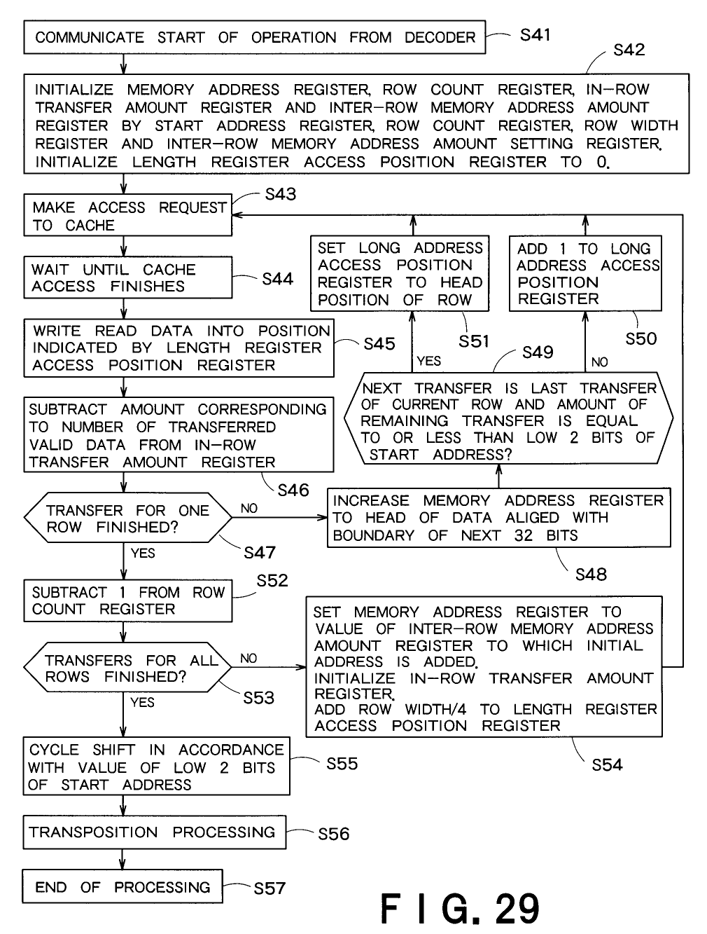

FIG. 29 is a flowchart showing one example of the processing operation by the controller 5 according to the fifth embodiment. The flowchart in FIG. 29 has step S56 for the transposition processing which is added after step S55 in FIG. 16, and is the same as the flowchart in FIG. 16 except for the processing in step S56.

In step S56, data are rearranged in the length register 4 after the cyclic shift in accordance with the row width of the rectangular area 10.

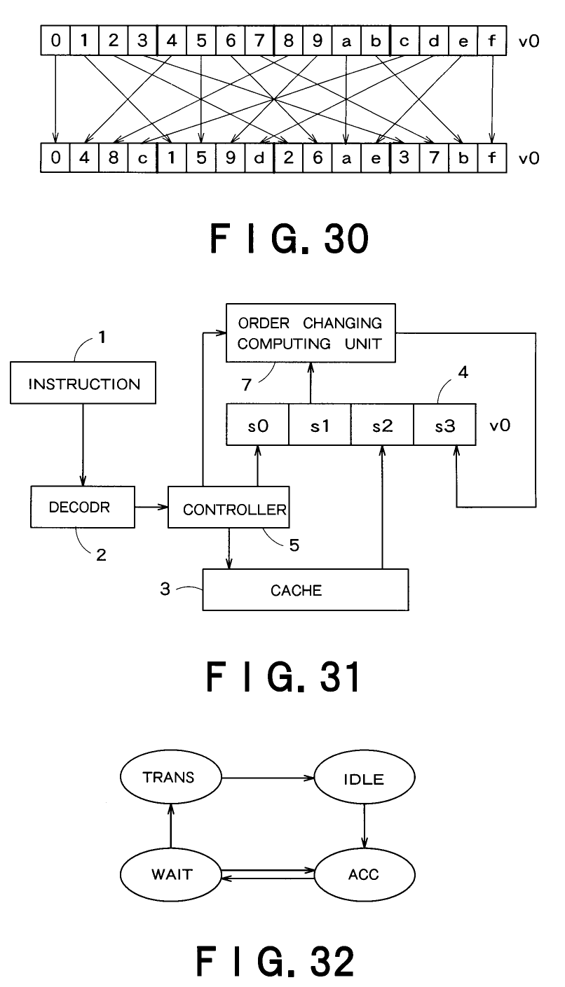

FIG. 30 is a diagram explaining the transposition processing in the length register 4. An upper stage in FIG. 30 indicates data in the length register 4 before the transposition processing, and a lower stage indicates data in the length register 4 after the transposition processing. 1-byte data moves in the directions of arrows in FIG. 30.

Thus, in the fifth embodiment, the transposition processing is specified by one instruction and carried out by hardware, so that overhead required for matrix operation can be lower than when the transposition processing is carried out by a normal instruction set.

### Sixth Embodiment

While the transposition processing has been described in the fifth embodiment in the case where the start address of the rectangular area 10 is not located at the boundary of 32 bits, the transposition processing can also be performed after the cyclic shift in the case where the start address of the rectangular area 10 is located at the boundary of 32 bits (fourth embodiment).

FIG. 31 is a block diagram showing the schematic configuration of a data transfer apparatus according to a sixth embodiment of the present invention. The data transfer apparatus in FIG. 31 has a configuration in which the mask controller 6 is eliminated from the configuration in FIG. 27. In the data transfer apparatus in FIG. 31, the start address is located at the boundary of 32 bits, so that mask processing is unnecessary.

FIG. 32 is a diagram showing the configuration of a state machine of a central processor in a controller 5 according to the sixth embodiment. The state machine in FIG. 32 has four operation states in which the state ROTATE is eliminated from FIG. 28. In the sixth embodiment, the start address is located at the boundary of 32 bits, so that cyclic shift processing is unnecessary and the state ROTATE is not present. After the state WAIT has terminated, the transition is made to the state TRANS to carry out the transposition processing.

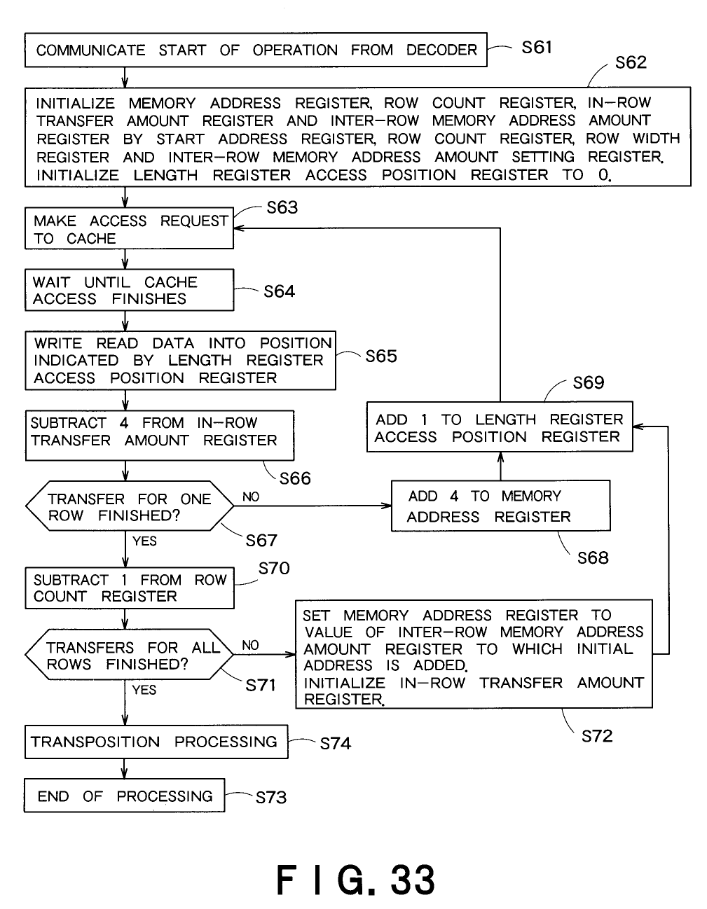

FIG. 33 is a flowchart showing one example of the processing operation by a controller 5 according to the sixth embodiment. To the flowchart in FIG. 33, step S74 is added for performing the transposition processing when it is judged in step S71 in FIG. 24 that the data transfers for all the rows have been finished, and the flowchart in FIG. 33 is the same as the flowchart in FIG. 24 except for the processing in step S73.

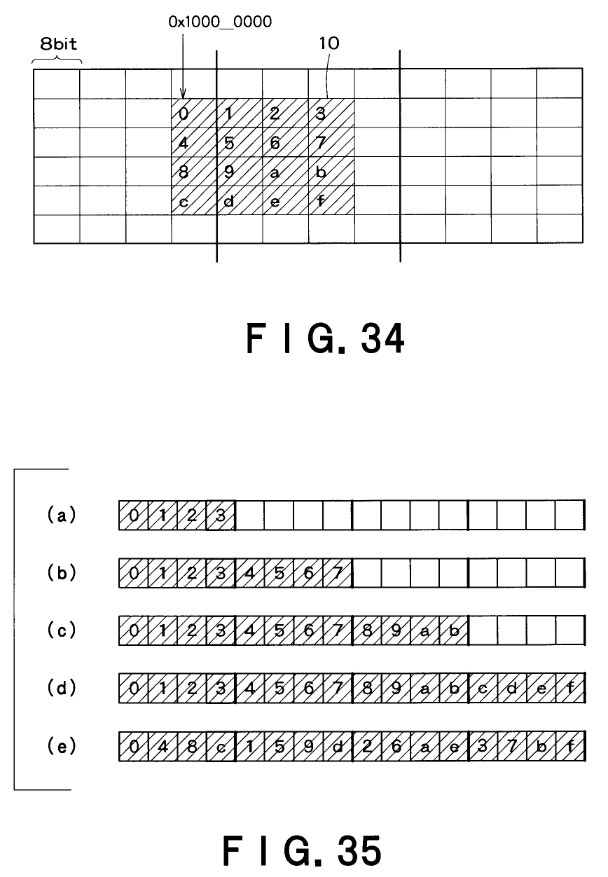

FIG. 34 is a diagram showing one example of data in the rectangular area 10 to be transferred and transposed in a cache memory 3, and FIG. 35 are diagrams showing the values of a length register 4 after data transfer. During the first data transfer, 32-bit data in the first row is transferred as shown in FIG. 35(a). In the same manner, FIGS. 35(b) to 35(d) indicate the values of the length register 4 after the second, third and fourth data transfers.

When the fourth data transfer is finished, the transposition processing is performed as shown in FIG. 35(e) and data are rearranged byte by byte.

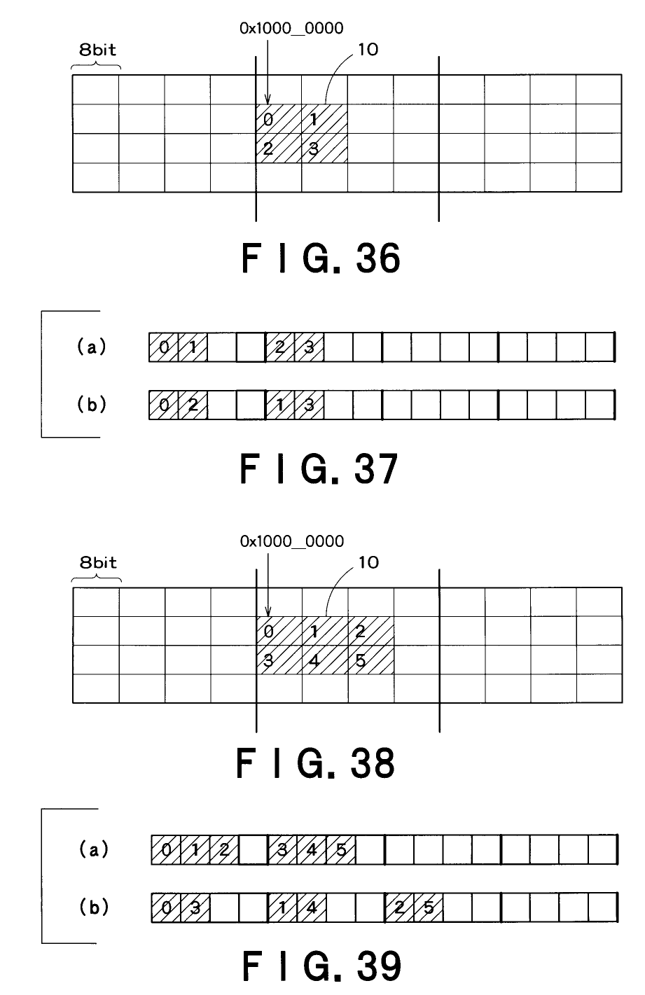

While the example has been described with FIG. 34 in connection with the transfer of data in the rectangular area 10 composed of four rows in which one row has 4 bytes (32 bits), the rows and columns of the rectangular area 10 are not specifically limited in size. For example, FIGS. 36 and 37 show an example of the transfer of data in the rectangular area 10 composed of 2 rows in which one row has 2 bytes. In this case, when the transfer of the data in the rectangular area 10 is finished, 2-byte data in the first row and 2-byte data in the second row are stored starting from the respective breakpoint positions in accordance with the breakpoints of 32-bit data, as shown in FIG. 37(a). Then, the transposition processing is performed every 32 bits, as shown in FIG. 37(b).

Furthermore, FIGS. 38 and 39 show an example of the transfer of data in the rectangular area 10 composed of 2 rows in which one row has 3 bytes. In this case, when the transfer of the data in the rectangular area 10 is finished, 3-byte data in the first row and 3-byte data in the second row are stored starting from the respective breakpoint positions in accordance with the breakpoints of 32-bit data, as shown in FIG. 38(a). Then, the transposition processing is performed by 32 bits as shown in FIG. 38(b), and data are stored by 2 bytes from the positions of three breakpoints.

Thus, in the sixth embodiment, the transposition processing can be performed in hardware to transfer the rectangular area 10 in the cache memory 3 to the length register 4 and rearrange the rows and columns of the rectangular area 10, so that the data transfer and the transposition processing can be indicated by a simple instruction, and an increased velocity of the processing and the simplification of the instruction can be achieved.

While the examples have been described in the above embodiments in which data is transferred from the cache memory 3 to the length register 4, the memory from which data is transferred does not necessarily have to be the cache memory 3, and various memories from which data stored therein can be read are applicable to such a memory.

What is claimed is:

1. A data transfer apparatus, comprising:
a controller configured to read out data in a predetermined sequential address area in units of a first byte count and to perform control for transferring the read-out data to a length register having a data area of a second byte count, the second byte count being the first byte count n times, where n is an integer equal to or more than “1”;
a mask generator configured to generate mask information so that data already stored into the length register is not overwritten and to provide the controller with the mask information, when last data included in data in the predetermined address range read out from the memory is stored into the length register; and
a bit circular configured to circulate each bit of data stored in the length register by the number of bytes in accordance with a lower side bit string of a start address of data in the predetermined address area read out from the memory.

2. The data transfer apparatus according to claim 1,
wherein the controller, the mask generator and the bit circular perform operations depending on one instruction indicating that data in the predetermined sequential address area in the memory is transferred to the length register.

3. The data transfer apparatus according to claim 1,
wherein the controller includes:
a memory address register configured to store a memory address to access a specified data area in the memory;
a length register access location register configured to store an address to access an arbitrary data area in the length register;
a present transfer count register configured to store a value relating to data amount transferred from the memory to the length register;
a transfer count generator configured to calculate a difference between the memory address stored into the memory address register and a breakpoint address in case of reading out data from the memory, based on the lower side bit string of the memory address stored into the memory address register;
a first adder configured to generate a memory address to be next stored into the memory address register based on the difference calculated by the transfer count generator; and
a second adder configured to calculate a value to be next stored into the present transfer count register based on the difference calculated by the transfer count generator.

4. The data transfer apparatus according to claim 3,
wherein the controller includes:
a transfer count register configured to store the number of bytes of data transferred from the memory to the length register; and
a transfer count determination part configured to determine whether data transfer for the number of bytes stored into the transfer count register is completed,
wherein the bit circular circulates data when the transfer count determination part determines that the transfer is completed.

5. The data transfer apparatus according to claim 4,
wherein the transfer count determination part stores a next read-out start address into the memory address register when the transfer count determination part determines that the transfer is not yet completed.

6. The data transfer apparatus according to claim 1,
wherein the mask generator generates the mask information in units of bytes; and
the controller extracts partial data among data of the first byte count read out from the memory based on the mask information to perform control for transferring the data to the length register, when last data in the predetermined address area is transferred.

7. The data transfer apparatus according to claim 1,
wherein the number of bytes circulated by the bit circular is a value less than the first byte count being units of reading out the memory.

8. The data transfer apparatus according to claim 1,
wherein the number of bits of the lower side bit string is n bits when data is transferred from the memory to the length register in units of 2ⁿ bytes, where n is an integer equal to or more than “1”.

9. The data transfer apparatus according to claim 1, further comprising:
a register controller configured to set a value of the length register access location register to “0” when data to be next transferred is last data in the predetermined address area and when the amount of untransferred data is equal to or less than the number of bytes indicated by a value of the lower side bit string of the start address in the predetermined address area, and to increase the value of the length resister access location register by “1” when data to be next transferred is not last data in the predetermined address area, or when the amount of untransferred data is larger than the number of bytes indicated by the value of the lower side bit string of the start address in the predetermined address area.

10. The data transfer apparatus according to claim 1,
wherein the memory is a cache memory; and
the controller controls data transfer from the cache memory to the length register in a processor.

11. A data transfer apparatus, comprising:
a controller configured to read out data in a rectangular area in a memory in units of a first byte count and to perform control for transferring the read-out data to a length register having a data area of a second byte count, the second byte count being the first byte count n times, where n is an integer equal to or more than “1”;
a mask generator configured to generate mask information so that data already stored into the length register is not overwritten and to provide the controller with the mask information;
a bit circular configured to circulate each bit of data stored in the length register by the number of bytes in accordance with a lower side bit string of a start address of data in a predetermined area read out from the memory.

12. The data transfer apparatus according to claim 11,
wherein the controller, the mask generator and the bit circular perform operations depending on one instruction indicating that data in the predetermined area in the memory is transferred to the length register.

13. The data transfer apparatus according to claim 11,
wherein the controller includes:
a memory address register configured to store a memory address to access a specified data area in the memory;
a length register access location register configured to store an address to access an arbitrary data area in the length register;
an in-row transfer amount register configured to store a value relating to the amount of transferring data from the memory to the length register, with respect to a row to be read out from the rectangular area;
a row count register configured to count the number of rows of data already transferred from the memory to the length register;
a next candidate selector configured to select a start address at a next data transfer timing in a row to be read out from the rectangular area;
a transfer count generator configured to calculate a difference between the memory address stored into the memory address register and a breakpoint address in case of next reading out data from the memory, based on the lower side bit string of the memory address stored into the memory address register;
a first adder configured to generate a memory address to be next stored into the memory address register based on the difference calculated by the transfer count generator; and
a second adder configured to calculate a value to be next stored into the in-row transfer amount register based on the difference calculated by the transfer count generator.

14. The data transfer apparatus according to claim 11,
wherein the controller includes:
a row count register configured to store the number of rows in the rectangular area; and
a row count determination part configured to determine whether or not transfer for the row count stored into the row count register is completed,
wherein the bit circular circulates data when the transfer count determination part determines that the transfer is completed.

15. The data transfer apparatus according to claim 14,
wherein the controller has an inter-row memory address amount setting register configured to store the amount of an inter-row memory address in the rectangular area; and
when the row count determination part determines that the transfer is not yet completed, the memory address register stores a sum of an initial address and the inter-row memory address amount, the in-row transfer count register is initialized, and a value corresponding to a row width of the rectangular area is stored into the length register access location register.

16. The data transfer apparatus according to claim 11,
wherein the mask generator generates the mask information in units of bytes; and
the controller extracts partial data among data of the first byte count read out from the memory based on the mask information, when last data in the rectangular area is transferred.

17. The data transfer apparatus according to claim 11,
wherein the number of bytes circulated by the bit circular is a value less than the first byte count being units of reading out the memory.

18. The data transfer apparatus according to claim 11,
wherein the number of bits of the lower side bit string is n bits when data is transferred from the memory to the length register in units of 2ⁿ bytes, where n is an integer equal to or more than “1”.

19. The data transfer apparatus according to claim 11,
wherein the controller includes:
a row transfer determination part configured to determine whether data transfer for one row in the rectangular area is completed after one data transfer is completed;
a memory address setting part configured to set a breakpoint address in case of reading out data from the memory to the memory address register when the row transfer count determination part determines that data transfer is not completed; and
a register controller configured to set a value of the length register access location register to “0” when the address set by the memory address setting part corresponds to last data transfer in the corresponding row and when the amount of untransferred data is equal to less than the number of bytes indicated by a value of the lower side bit string in the start address in the rectangular area, and increases the value of the length register access location register by “1” when data to be next transferred does not correspond to a last data transfer in the corresponding row, or the amount of untransferred data is larger than the number of bytes indicated by the value of the lower side bit string of the start address in the rectangular area.

20. The data transfer apparatus according to claim 11, further comprising a transposed processing part configured to transpose data of the length register after being circulated by the bit circular to data sequence transposing rows to columns in the rectangular area.
